(19) United States
(12) Patent Application Publication
(10) Pub. No.: US 2026/0054976 A1
(43) Pub. Date: Feb. 26, 2026

(54) LOADING PIPE, AGRICULTURAL EQUIPMENT PROVIDED WITH THE SAME, KIT FOR ASSEMBLING, AND CORRESPONDING METHODS OF MANUFACTURING, ASSEMBLING AND OPERATING ASSOCIATED THERETO

(71) Applicant: GEA FARM TECHNOLOGIES CANADA INC./DIVISION GEA HOULE, Drummondville (CA)

(72) Inventors: Yann Desrochers, Drummondville (CA); Jeramy Sanford, Coldwater, MI (US)

(21) Appl. No.: 19/105,722

(22) PCT Filed: Aug. 22, 2023
(86) PCT No.: PCT/CA2023/051110

§ 371 Date: Feb. 21, 2025

Related U.S. Application Data
(60) Provisional application No. 63/373,125, filed on Aug. 22, 2022.

(51) Int. Cl. B67D 7/08; B67D 7/02

(52) U.S. Cl. CPC B67D 7/08; B67D 7/0288

(57) ABSTRACT

A loading pipe for conveying a substantially liquid material from a first location to a second location. The loading pipe includes a main body having an inlet and an outlet, the inlet being operatively connectable to the first location, and the outlet being operatively connectable to the second location, the main body of the loading pipe defining a fluid path along which the substantially liquid material is allowed to travel from inlet to outlet thereof. The loading pipe also includes at least one reading component operatively mounted about the main body and capable of interacting with the substantially liquid material travelling inside the main body of the loading pipe for collecting at least one corresponding reading and associated value.

### FIELD OF THE INVENTION

The present invention relates to the field of loading pipes. More particularly, the present invention relates to a new loading pipe, and also relates to an agricultural equipment provided with the same, to a kit with corresponding components for assembling either the loading pipe and/or the agricultural equipment, and to corresponding methods of manufacturing, assembling and/or operating associated thereto.

### BACKGROUND

The Assignee of the present patent application has developed over the years various systems and products to be used in the agricultural and/or farming field, and/or the like, some of which are described and/or illustrated in the following US utility and design patents having been granted (and/or following published patents applications as well), for example: U.S. Pat. Nos. 5,364,116; 5,435,493; 6,044,980 B2; 7,121,483 B2; 8,544,383 B2; 9,101,861 B2; 9,357,749 B2; 10,463,018 B2; 11,272,684 B2; D354,290; D791,422; and D818,354 (US-2003-0039566-A1; US-2014-0056743-A1; and US-2016-0369219-A1), the content(s) of which are entirely and/or selectively incorporated by reference.

Examples of systems and products having been developed by the Assignee of the present patent application are also described and/or illustrated in the following Canadian patent documents (whether published and/or granted): 2,110,333; 2,121,994; 2,196,443; 2,355,811; 2,393,987; 2,461,113; 2,678,834; 2,678,839; 2,727,011; 2,773,906; 2,785,222; 2,828,614; 2,891,676; 2,926,841; 2,934,373; 3,128,326; as well as corresponding Industrial Designs Nos. 73,864 and 170,766, the content(s) of which are also entirely and/or selectively incorporated by reference.

Examples of systems and products having been developed by the Assignee of the present patent application are also described and/or illustrated in the following International patent documents (either PCT patent applications having been published and/or recently filed): WO 2011/029200; WO 2011/029205; WO 2011/091530; WO 2012/019279; WO 2012/019280; WO 2012/119251; WO 2014/075192; WO 2015/051470; WO 2015/109403; and WO/2023/019352, the content(s) of which are entirely and/or selectively incorporated by reference.

Known to the Applicant is U.S. Pat. No. 10,694,661 B2, granted on Jun. 30, 2020, in the name of NUHN, and relating to “SELF-PROPELLED FILLING PIPE”. This document describes a self-propelled filling pipe for a liquid manure spreader has a frame, an elongated pipe on the frame having a lower inlet end and an elevated outlet end, at least two wheels mounted on the frame, a caster wheel mounted on the elongated pipe proximate the lower inlet end and a fluid drive system. The fluid drive system includes a hydraulic pump, a first hydraulic circuit connecting the hydraulic pump to a plurality of hydraulic motors drivingly connected to the wheels. The fluid drive system also includes a second hydraulic circuit connecting the hydraulic pump to a hydraulic motor operatively connected to the caster wheel. A prime mover provides power to the hydraulic pump to power the hydraulic motors to rotate the caster wheel thereby steering the filling pipe and/or to drive the wheels thereby propelling the filling pipe on the ground.

Despite these improvements over the years, there is always a need to continue innovating and finding better and/or different ways of loading/filling manure (ex. from a pit to a corresponding tank, for example), and to be able to do so, in a quicker, easier, simpler, faster, smarter, more efficient, more convenient, more reliable, more secure, more versatile, more sustainable, more predictable, more controllable and/or more desirable manner.

Indeed, and today, the conventional method of agitating manure pits and filling spreader tank to haul manure to the field for fertilization purposes is to use a tractor driven pump to mix and homogenize the content of the manure pit. Typically, an operator in the tractor controls the agitation devices and ensure the content of the pit is fully mixed before starting to fill spreader tanks. To fill the spreaders, a loading pipe is generally attached to the end of the discharge pipe of the pump and the end of that loading pipe stands at approximately 12 feet from the ground. Spreader tanks will come, one after the other, and park right under the filling pipe. Typically also, the filling opening on the top of the spreader needs to be aligned with the end of the filling pipe. Once in position, the operator in the pump tractor switches the pump from agitation to “loading” mode. The operator must control the throttle to fill the spreader as fast as possible, but he must also be careful not to create foam inside the spreader. When the level gets near the top, the operator must reduce the throttle to slow the filling process and be able to fill the spreader as close to the top as possible without splashing manure outside.

A loading pipe usually consists of a steel or aluminum pipe equipped with a certain length of flexible hose and an elbow at the other end. It usually has its own support in the form of supporting legs and/or it can be mounted on wheeled trailer. Typically, it is connected to the tractor driven pump discharge pipe with the flexible hose and the elbowed end must be high enough for the spreaders to park underneath.

It is also known that liquid manure is a valuable fertilizer. Farmers spread this fertilizer on their field to help their crop to yield, build strong roots and produce fruits. The application of this fertilizer must be adapted to the capacity of their land to absorb certain nutrients such as the phosphorus (P), the nitrogen (N) and the potassium (K), for example. Precision manure application has become the new way to apply manure. First, the soil is analyzed in different portion(s) of the field. Typically also, the maximum amount(s) of nutrients (N, P, K) the field can take is then mapped in a software. To apply as much fertilizer as possible on the field without exceeding the amount of nutrient as per the analysis, each spreader load is analyzed and the amount of manure per acre is adjusted as the spreader gets to certain portion(s) of the field. Very often, a GPS monitors the location of the spreader in the field and will control the manure flow according to the previously mapped field.

To achieve all this, today's spreader must be equipped with GPS, flow meter, flow control valves and a NIR sensor (i.e., a “Near InfraRed” Sensor), and typically, it is this optical sensor that analyzes the liquid manure to determine the concentration of nutrient in real time (ex. to determine NPK content of manure, etc.). This technology is very expensive and custom haulers often own a fleet of 10 to 20 spreader tanks. Equipping each and every one of them with a NIR sensor could become too much of an investment for many.

In the end, the challenges that farmers and custom operators face today are shortage of labor, a limited time window to spread manure during spring and fall seasons, a limited budget, and the need to precisely apply different amount of manure in specific areas of a field.

Therefore, in view of the above, it would be particularly useful and/or advantageous to be able to provide an improved loading pipe which would be able to overcome or at the very least minimize some of known drawbacks associated with conventional loading pipes and the like, for example.

### SUMMARY OF THE INVENTION

An object of the present invention is to provide a loading pipe which, by virtue of its design and components, would be an improvement over other related loading pipes, loading methods and/or the like known in the prior art.

In accordance with the present invention, the above object is achieved, as will be easily understood from the present description, with a “loading pipe” (also referred to herein simply as “pipe”, “system” and/or “concept”) such as the one briefly described herein and such as the one exemplified in the accompanying drawing(s).

More particularly, according to one aspect of the present invention, an object is to provide a loading pipe for conveying a substantially liquid material from a first location to a second location, the loading pipe comprising:
a main body having an inlet and an outlet, the inlet being operatively connectable to the first location, the main body of the loading pipe defining a fluid path along which the substantially liquid material is allowed to travel from inlet to outlet thereof; and
at least one reading component operatively mounted about the main body and capable of interacting with the substantially liquid material travelling inside the main body of the loading pipe for collecting at least one corresponding reading and associated value.

As can be easily understood, the outlet may simply hang down and liquid gets out to fill a separate container such as a spreader tank (for example) and/or other, and thus, one may or may not have a solid connection there. Other suitable equivalents and/or alternatives are also contemplated by the present disclosure for the outlet.

According to yet another aspect of the invention, there is also provided an agricultural equipment provided with the above-mentioned.

According to yet another aspect of the invention, there is also provided a method of manufacturing components of the above-mentioned loading pipe and/or agricultural equipment.

According to yet another aspect of the invention, there is also provided a method of assembling components of the above-mentioned loading pipe and/or agricultural equipment.

According to yet another aspect of the invention, there is also provided a method of using the above-mentioned loading pipe, agricultural equipment and/or component(s) thereof.

According to yet another aspect of the invention, there is also provided a kit with components for assembling the above-mentioned loading pipe and/or agricultural equipment.

According to yet another aspect of the present invention, there is also provided a set of components for interchanging with components of the above-mentioned kit.

According to yet another aspect of the present invention, there is also provided a method of assembling components of the above-mentioned kit and/or set.

According to yet another aspect of the present invention, there is also provided a method of dispensing manure and/or any other type of mixture, with the above-mentioned loading pipe, agricultural equipment, component(s) thereof, kit, set and/or method(s).

According to yet another aspect of the present invention, there is also provided an agricultural site provided with the above-mentioned loading pipe, agricultural equipment, component(s) thereof, kit, set, method(s), manure and/or any other type of mixture to be dispensed.

According to yet another aspect of the present invention, there is also provided a method of doing business with the above-mentioned loading pipe, agricultural equipment, component(s) thereof, kit, set, method(s), site, manure and/or any other type of mixture to be dispensed.

The objects, advantages, and other features of the present invention will become more apparent upon reading of the following non-restrictive description of preferred embodiments thereof, given for the purpose of exemplification only, with reference to the accompanying drawing(s).

### BRIEF DESCRIPTION OF THE DRAWINGS

FIG. 1 is a schematic representation of a loading pipe (and/or associated system) according to a possible embodiment of the present invention.

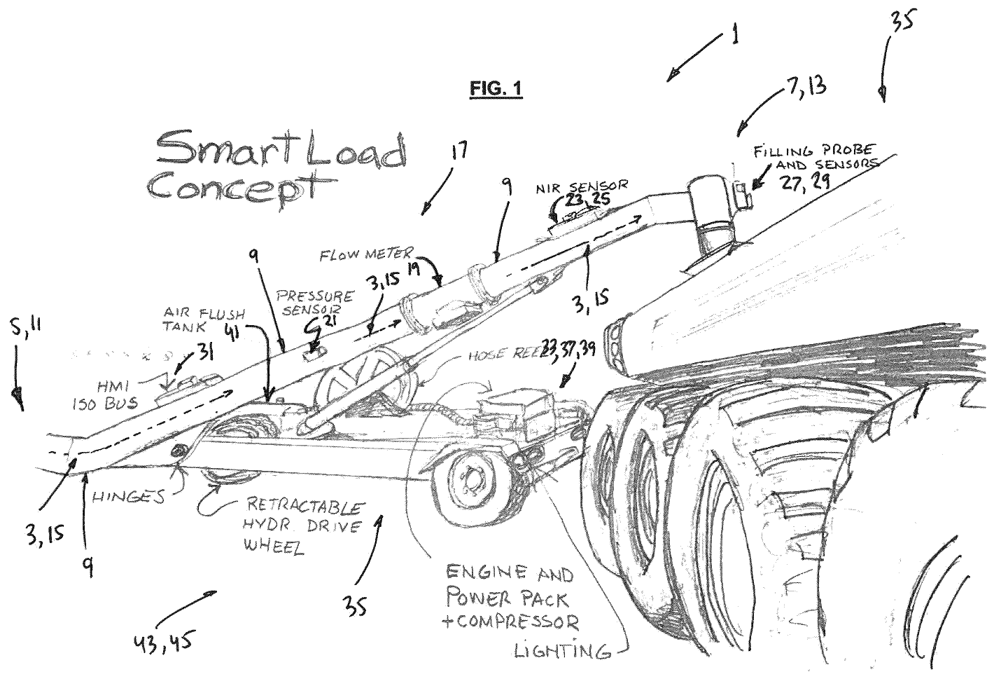

### DETAILED DESCRIPTION OF PREFERRED EMBODIMENTS OF THE INVENTION

In the following description, the same numerical references refer to similar elements. Furthermore, for sake of simplicity and clarity, namely so as to not unduly burden the figures with several reference numbers, only some figures have been provided with reference numbers, and components and features of the present invention illustrated in other figures can be easily inferred therefrom. The embodiments, geometrical configurations, materials mentioned and/or dimensions shown in the figures are preferred, for exemplification purposes only.

Moreover, although the present invention was primarily designed for use with manure and/or any other suitable type of mixture (ex. preferably in a substantially liquid form, etc.), for example, it may be used with other objects and/or in other types of applications, as apparent to a person skilled in the art. For this reason, expressions such as “manure”, “mixture”, “liquid”, etc., used herein should not be taken so as to limit the scope of the present invention and include all other kinds of objects and/or applications with which the present invention could be used and may be useful. For example, the present loading pipe could also be used with and/or for various other products that may be subject to “shear” and/or that may be of “granular” nature, for instance, as well as various “other” products that can be used for conducting through a pipe, as can be easily understood by a person skilled in the art.

Moreover, in the context of the present invention, the expressions “loading pipe”, “dispenser”, “assembly”, “machine”, “system”, “concept”, “device”, “apparatus”, “product”, “unit”, “equipment”, “tool”, “method” and “kit”, as well as any other equivalent expression(s) and/or compound word(s) thereof known in the art will be used interchangeably, as apparent to a person skilled in the art. This applies also for any other mutually equivalent expressions, such as, for example: a) “loading”, “charging”, “filling”, “dispensing”, “distributing”, “providing”, “spreading”, etc. ; b) “manure”, “mixture”, “liquid”, “fluid”, “granular”, etc. ; as well as for any other mutually equivalent expressions, pertaining to the aforementioned expressions and/or to any other structural and/or functional aspects of the present invention, as also apparent to a person skilled in the art. Also, in the context of the present description, expressions such as “can”, “may”, “might”, “will”, “could”, “should”, “would”, etc., may also be used interchangeably, whenever appropriate, as also apparent to a person skilled in the art.

Furthermore, in the context of the present description, it will be considered that all elongated objects will have an implicit “longitudinal axis” or “centerline”, such as the longitudinal axis of shaft for example, or the centerline of a coiled spring (and/or a tube), for example, and that expressions such as “connected” and “connectable”, or “mounted” and “mountable”, may be interchangeable, in that the present invention also relates to a kit with corresponding components for assembling a resulting fully-assembled and fully-operational loading pipe, as well as associated agricultural equipment.

Moreover, components of the present system(s) and/or steps of the method(s) described herein could be modified, simplified, altered, omitted and/or interchanged, without departing from the scope of the present invention, depending on the particular applications which the present invention is intended for, and the desired end results, as briefly exemplified herein and as also apparent to a person skilled in the art.

In addition, although the preferred embodiments of the present invention as illustrated in the accompanying drawings comprise various components, and although the preferred embodiments of the present loading pipe and corresponding portion(s)/part(s)/component(s) as shown consist of certain geometrical configurations, as explained and illustrated herein, not all of these components and geometries are essential to the invention and thus should not be taken in their restrictive sense, i.e., should not be taken so as to limit the scope of the present invention. It is to be understood, as also apparent to a person skilled in the art, that other suitable components and cooperation therein between, as well as other suitable geometrical configurations may be used for the present loading pipe and corresponding portion(s)/part(s)/component(s) according to the present invention, as will be briefly explained herein and as can be easily inferred here from by a person skilled in the art, without departing from the scope of the present invention.

### LIST OF NUMERICAL REFERENCES FOR SOME OF THE CORRESPONDING POSSIBLE COMPONENTS ILLUSTRATED IN THE ACCOMPANYING DRAWING(S):

1. loading pipe
3. liquid manure
5. first location
7. second location
9. main body
11. inlet
13. outlet
15. fluid path
17. reading component
19. flow meter (ex. magnetic flow meter)
21. pressure sensor
23. nutrient sensor
25. optical sensor (ex. Near-InfraRed (NIR) sensor)
27. level sensor (ex. a probe, a lidar, a sonar, etc.)
29. visual sensor (ex. camera, etc.)
31. HMI (Human Machine Interface)
33. connection
35. agricultural equipment (and/or vehicle)
37. ISOBUS connection
39. driving component (ex. PTO of tractor)
41 air flushing system
43. complementary component (ex. controller, computer, proximity sensor, etc.)
45. other component

Broadly described, and as better exemplified in the accompanying drawings, the present invention relates to a loading pipe capable that would address the aforementioned challenges by creating a high-tech loading pipe that would take control of the tractor's driven pump to optimize the filling process and by analyzing the manure content, using NIR technology (for instance), to send a report to the spreader computer for precision manure application purposes, something that is not possible with other conventional loading pipes.

The present loading pipe, as better exemplified in the accompanying drawings, and described hereinbelow, may be commercialized under the name “Smartload”, “SmartLoad”, “SL”, “Smart Loading Pipe”, “SLP”, Smart Loading Pipe System”, “SLPS” and/or various other possible/suitable permutations, derivations, variations, abbreviations and/or translations thereof ((all of) which is(are) trademark expression(s) considered by and/or own by the Applicant of the present case), and the present loading pipe (1) may come in the form of a loading pipe (1) including one and/or several of the following possible components and features (and/or different possible combination(s) and/or permutation(s) thereof):
a) a magnetic flow meter and/or a pressure sensor to determine loading performance;
b) an ISOBUS connection with the farm tractor to take control of the throttle and/or PTO activation;
c) a NIR sensor to analyze nutrient content(s);
d) a probe and/or lidar and/or sonar to read manure level in the tank;
e) a camera to provide an aerial view to the operator via an HMI (Human Machine Interface), for example; and/or
f) an air flushing system to drain the remaining liquid back to the pit.

The present loading pipe (1) may come in the form of a loading pipe (1) including one and/or several of the following possible components and features (and/or different possible combination(s) and/or permutation(s) thereof):
i.) A loading pipe for conveying a substantially liquid material from a first location to a second location, the loading pipe comprising:
a main body having an inlet and an outlet, the inlet being operatively connectable to the first location, and the outlet being operatively connectable to the second location, the main body of the loading pipe defining a fluid path along which the substantially liquid material is allowed to travel from inlet to outlet thereof; and
at least one reading component operatively mounted about the main body and capable of interacting with the substantially liquid material travelling inside the main body of the loading pipe for collecting at least one corresponding reading and associated value.
ii.) A loading pipe according to any one of the preceding combination(s), wherein the loading pipe includes a magnetic flow meter for reading a corresponding flow value of the substantially liquid material conveyed by the loading pipe.
iii.) A loading pipe according to any one of the preceding combination(s), wherein the loading pipe includes a pressure sensor for reading a corresponding pressure value of the substantially liquid material conveyed by the loading pipe.
iv.) A loading pipe according to any one of the preceding combination(s), wherein the loading pipe includes a nutrient sensor for reading a corresponding nutrient value of the substantially liquid material conveyed by the loading pipe.
v.) A loading pipe according to any one of the preceding combination(s), wherein the nutrient sensor includes a Near-InfraRed (NIR) sensor to analyze nutrient content(s) of the substantially liquid material conveyed by the loading pipe.
vi.) A loading pipe according to any one of the preceding combination(s), wherein the loading pipe is provided with a level sensor for reading a corresponding level value (ex. inside the tank).
vii.) A loading pipe according to any one of the preceding combination(s), wherein the level sensor is selected from the group consisting of a probe, a lidar and a sonar (ex. to read manure level in the tank, for instance).
viii.) A loading pipe according to any one of the preceding combination(s), wherein the loading pipe is provided with a visual sensor for providing a corresponding visual representation.
ix.) A loading pipe according to any one of the preceding combination(s), wherein the visual sensor includes a camera to provide an aerial view to an operator of the loading pipe (ex. via an HMI (Human Machine Interface), for instance).
x.) A loading pipe according to any one of the preceding combination(s), wherein the loading pipe is provided with a connection capable of interacting with a corresponding agricultural equipment and/or vehicle for selectively controlling at least one corresponding parameter (ex. operating parameter, etc.) of said equipment and/or vehicle.
xi.) A loading pipe according to any one of the preceding combination(s), wherein the connection of the loading pipe includes an ISOBUS connection configured for interacting with a driving component of the agricultural equipment and/or vehicle.
xii.) A loading pipe according to any one of the preceding combination(s), wherein the connection of the loading pipe includes an ISOBUS connection configured for interacting with a corresponding throttle and/or a power take-off (“PTO”) of a hauling vehicle (such as a tractor, for instance, although other types of hauling devices are also contemplated for the present loading pipe system).
xiii.) A loading pipe according to any one of the preceding combination(s), wherein the loading pipe is provided with an air flushing system (ex. to drain the remaining liquid back to the pit, for instance).
xiv.) A loading pipe according to any one of the preceding combination(s), wherein the loading pipe is provided with a complementary component selected from the group consisting of a controller, a computer and a proximity sensor.
xv.) A loading pipe according to any one of the preceding combination(s), wherein the loading pipe includes at least one component and/or feature such as the one(s) described in the present patent specification, and/or such as can be easily inferred therefrom.
xvi.) An agricultural equipment (ex. tractor, etc.) being provided with a loading pipe according to any one of the preceding combination(s).
xvii.) A kit with corresponding components for assembling a loading pipe such as the one described and/or illustrated in the present patent specification.

As can be easily understood, in addition to the various innovative components and features of the present system, and explained and/or exemplified in the present patent specification, the loading pipe (1) according to the present invention could also be provided with various other known components and features of other conventional loading pipes and the like being well known (ex. display, electronics, safety features, etc.), as apparent to a person skilled in the art.

As may now be better appreciated, the present loading pipe (1) is a considerable improvement over conventional systems in that it overcomes the many drawbacks and inconveniences associated with conventional loading pipes, in that:
a) it is based on an “automatic filling” approach, given that, according to possible embodiment(s), as exemplified herein, the loading pipe may be equipped with a flow meter, a pressure sensor, a liquid level probe, proximity sensors, a controlling device and/or an ISOBUS connection, and given that the controlling device can advantageously take control of the tractor PTO and/or engine throttle, etc.;
b) it allows to optimize the filling process while eliminating a labor-intensive task; and
c) it is based on a “precision manure application” approach, given that, according to possible embodiment(s), as exemplified herein: the loading pipe may be equipped with a flow meter, as well as a pressure sensor and a nutrient content sensor (ex. NIR and/or other). Therefore, and according to a possible embodiment of the present system, after each load, the loading pipe (and/or system) records the total volume of liquid transferred as well as a nutrient concentration level for each nutrient (N, P, and K)-these values may be sent to a receiver in the spreader tank tractor cab (for example), and these values can then be used by the spreader to appropriately and advantageously apply manure in the field (for example), etc.

Furthermore, the present loading pipe (1) is advantageous in that it offers an innovative design with minimal components that can be modular and/or interchangeable depending on the applications(s) for which the loading pipe (1) is intended for, and the desired end result(s), and the present loading pipe (1) is also advantageous in that it enables to load a great variety of different types of commercial assets (ex. manure, mixture(s), etc.) with a same loading pipe (1), in a safe, clean, simple, compact, convenient and cost-effective manner.

The present loading pipe (1) and corresponding parts are preferably made of substantially rigid materials, such as metallic materials, hardened polymers, composite materials, polymeric materials, and/or the like, so as to ensure a proper operation thereof depending on the particular applications for which the loading pipe (1) is intended and the different parameters (pressures, temperatures, etc.) in cause, as apparent to a person skilled in the art.

Of course, and as can be easily understood by a person skilled in the art, the scope of the claims should not be limited by the possible embodiments set forth in the examples, but should be given the broadest interpretation consistent with the description as a whole.

Furthermore, although preferred embodiments of the present invention have been briefly described herein and illustrated in the accompanying drawings, it is to be understood that the invention is not limited to these embodiments and that various changes and modifications could be made without departing form the scope and spirit of the present invention, as apparent to a person skilled in the art.

1. A loading pipe for conveying a substantially liquid material from a first location to a second location, the loading pipe comprising:
a main body having an inlet and an outlet, the inlet being operatively connectable to the first location, and the outlet being operatively connectable to the second location, the main body of the loading pipe defining a fluid path along which the substantially liquid material is allowed to travel from inlet to outlet thereof; and
at least one reading component operatively mounted about the main body and capable of interacting with the substantially liquid material travelling inside the main body of the loading pipe for collecting at least one corresponding reading and associated value.

2. A loading pipe according to claim 1, wherein the loading pipe includes a magnetic flow meter for reading a corresponding flow value of the substantially liquid material conveyed by the loading pipe.

3. A loading pipe according to claim 1, wherein the loading pipe includes a pressure sensor for reading a corresponding pressure value of the substantially liquid material conveyed by the loading pipe.

4. A loading pipe according to claim 1, wherein the loading pipe includes a nutrient sensor for reading a corresponding nutrient value of the substantially liquid material conveyed by the loading pipe.

5. A loading pipe according to claim 4, wherein the nutrient sensor includes a Near-InfraRed (NIR) sensor to analyze nutrient content(s) of the substantially liquid material conveyed by the loading pipe.

6. A loading pipe according to claim 1, wherein the loading pipe is provided with a level sensor for reading a corresponding level value.

7. A loading pipe according to claim 6, wherein the level sensor is selected from the group consisting of a probe, a lidar and a sonar.

8. A loading pipe according to claim 1, wherein the loading pipe is provided with a visual sensor for providing a corresponding visual representation.

9. A loading pipe according to claim 8, wherein the visual sensor includes a camera to provide an aerial view to an operator of the loading pipe.

10. A loading pipe according to claim 1, wherein the loading pipe is provided with a connection capable of interacting with a corresponding agricultural equipment and/or vehicle for selectively controlling at least one corresponding parameter of said equipment and/or vehicle.

11. A loading pipe according to claim 10, wherein the connection of the loading pipe includes an ISOBUS connection configured for interacting with a driving component of the agricultural equipment and/or vehicle.

12. A loading pipe according to claim 10, wherein the connection of the loading pipe includes an ISOBUS connection configured for interacting with a corresponding throttle and/or a power take-off (PTO) of a hauling vehicle.

13. A loading pipe according to claim 1, wherein the loading pipe is provided with an air flushing system.

14. A loading according claim 1, wherein the loading pipe is provided with a complementary component selected from the group consisting of a controller, a computer and a proximity sensor.

15. An agricultural equipment being provided with a loading pipe according to claim 1.

16. A kit with corresponding components for assembling a loading pipe according to claim 1.
